(19) United States
(12) Patent Application Publication
(10) Pub. No.: US 2015/0193824 A1
(43) Pub. Date: Jul. 9, 2015

(54) DIGITAL SIGNAGE SYSTEM CAPABLE OF ENSURING ADVERTISEMENT EXPOSURE TIME AND METHOD THEREOF

(71) Applicant: Electronics and Telecommunications Research Institute, Daejeon-si (KR)

(72) Inventors: Uk JANG, Seoul (KR); Hyun-Jin LEE, Daejeon-si (KR); Kee-Seong CHO, Daejeon-si (KR); Won RYU, Seoul (KR)

(73) Assignee: Electronics and Telecommunications Research Institute, Daejeon-si (KR)

(21) Appl. No.: 14/291,486

(22) Filed: May 30, 2014

(30) Foreign Application Priority Data
Jan. 3, 2014 (KR) 10-2014-0000887

(51) Int. Cl. G06Q 30/02

(52) U.S. Cl. CPC G06Q 30/0257

(57) ABSTRACT

A digital signage system including a web-based digital signage platform that includes a controller configured to, in response to an event that an advertising content item stops to be played in a digital signage terminal due to an interactive content item requested to be played, allow a non-played part of the advertising content item to be played when the interactive content item is completely played. Accordingly, an advertisement exposure time is ensured.

### CROSS-REFERENCE TO RELATED APPLICATION(S)

This application claims the benefit under 35 U.S.C. §119(a) of Korean Patent Application No. 10-2014-0000887, filed on Jan. 3, 2014, in the Korean Intellectual Property Office, the entire disclosure of which is incorporated herein by references for all purposes.

### BACKGROUND

1. Field

The following description relates to a digital signage system, and, more particularly, to a digital signage system capable of playing advertising content and interactive content.

2. Description of the Related Art

Due to development of a display panel, not only the home appliances market, but also the Digital Information Display (DID) market has grown and expanded. The display panels used in industries have developed into digital signage, and they are now used as a communication tool for marketing, advertisements and customer experience. Digital signage is used as a digital image device that is installed at airports, hotels, hospitals and any public place to provide general broadcasts and specific information. In addition, digital signage provides even a software program and a management platform that controls primary functions of a commercial digital information display panel.

Now, digital signage has evolved from an existing medium for displaying static contents into a medium for displaying video contents. For example, digital signage includes a large electric display, a Liquid Crystal Display (LCD) installed in a subway or bus, a Plasma Display Panel (PDP) in a station and a DID. These examples are called the first-generation digital signage that displays and provide information in a unidirectional way. On the other hand, the second-generation digital signage provides information and advertisements, and even induces the public to participate in an advertising campaign using touch pad technologies and high-speed Internet technologies. That is, the digital signage has become a media that enables bi-directional communication or interaction. For example, by touching a specific part of a screen to shift the screen into an event page, a user is able to download a mobile coupon into the user's own mobile phone, and, by photographing a picture using a digital camera stored in the media, a user is able to immediately participate in an event with the picture.

Recently, almost all functions of a digital signage terminal are transferred to a digital signage platform in order to make the digital signage terminal compact. It accelerates the development of a web-based digital signage terminal which is capable of playing advertising contents using a web browser embedded in the digital signage terminal.

A plurality of advertising content items are simultaneously played on a single screen of a general digital signage terminal according to a predetermined schedule. Each advertising content item is played for a different period of time. However, as the digital signage service has been changed into a user participatory interactive service, an advertising content item stops to be played and instead an interactive content item starts in response to a request for the interactive content item. Due to the interactive content item, a preset exposure time of the advertising content item is not ensured.

### RELATED ART DOCUMENT

### Patent Document

Korean Laid-open Patent Publication No. 10-2011-0090158 (Published on Aug. 10, 2011)

### SUMMARY

The following description relates to a digital signage system capable of ensuring exposure time of advertising content.

In one general aspect, there is provided a digital signage system capable of ensuring an advertisement exposure time, the digital signage system including a digital signage platform configured to comprise a controller configured to, in response to an event that an advertising content stops to be played in a digital signage terminal due to an interactive content item requested to be played, allow a non-played part of the advertising content item to be played at a time when the interactive content item is completely played.

The controller may be further configured to reconfigure a layout in which the non-played part of the advertising content item is to be played.

The controller may be further configured to comprise an advertisement exposure manager configured to identify an exposure time of each of different advertising content items until the different advertising content items stops to be played, to calculate a remaining play time of each of the different advertising content items based on a total play time and the identified exposure time thereof, and to manage the calculated remaining play time; and a layout reconfigurator configured to reconfigure a layout based on management information of the advertisement exposure manager, and to provide the reconfigured layout to the digital signage terminal.

The advertisement exposure manager may be further configured to constantly receive a feedback on an exposure time of each of currently played advertising content item from the digital signage terminal.

The advertisement exposure manager may be further configured to calculate a weight of each of the different advertising content items based on the remaining play time thereof, and the layout reconfigurator is further configured to reconfigure a layout for each of the different advertising content items based on the calculated weight thereof.

The layout reconfigurator may be further configured to comprise a web page generator configured to generate a new web page with a layout reconfigured such that each of the different advertising content items are allocated with a different sized area according to a weight of each of the advertising content items; and a page transmitter configured to transmit information on the new web page when the interactive content is completely played.

In another exemplary embodiment, there is provided an advertisement exposure time ensuring method of a digital signage, the method including, in response to a request received from a digital signage terminal for an interactive content item when the digital signage terminal is playing advertising content items, providing a web page to play the interactive content items to the digital signage terminal; and in response to an event that the interactive content item is completely played, providing a web page to play a non-played part of each of the advertising content items.

The providing of a web page to play a non-played part of each of the advertising content items may include reconfiguring a layout in which the non-played part of each of the advertising content items is to be played.

The providing of a web page to play a non-played part of each of the advertising content items may further include identifying an exposure time of each of the advertising content items; calculating a remaining play time of each of the advertising content items based on a total play time and the identified exposure time thereof; calculating a weight of each of the advertising content items based on the calculated remaining play time; and reconfiguring a layout by allocating each of the advertising content items are allocated with a different sized area according to the calculated weight.

Other features and aspects may be apparent from the following detailed description, the drawings, and the claims.

### BRIEF DESCRIPTION OF THE DRAWINGS

FIG. 1 is a block diagram illustrating a digital signage system according to an exemplary embodiment;

FIG. 2 is a block diagram illustrating a digital signage platform according to an exemplary embodiment;

FIG. 3 is a reference diagram for explaining how to change a layout of a screen of a digital signage terminal according to an exemplary embodiment;

FIG. 4 is a flow chart illustrating operations of a digital signage system according to an exemplary embodiment; and

FIG. 5 is a chart illustrating information that is managed by an advertisement exposure manager according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

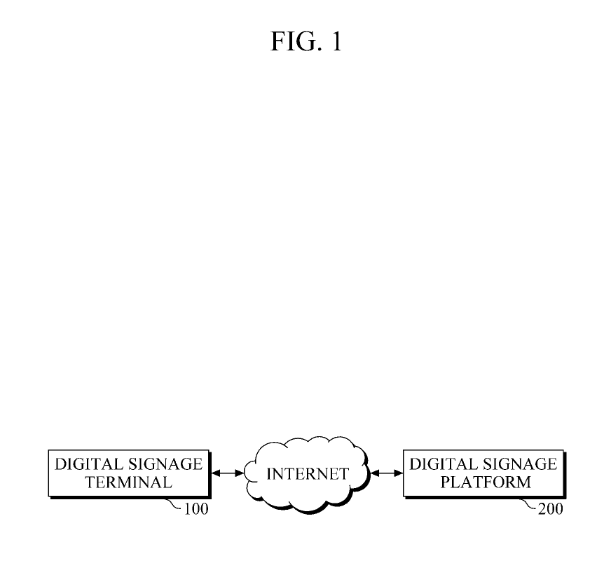

FIG. 1 is a block diagram illustrating a digital signage system according to an exemplary embodiment. As illustrated in FIG. 1, a digital signage system may include a digital signage terminal 100 and a digital signage platform 200. Alternatively, as contrary to FIG. 1, a digital signage system may include only the digital signage platform 200. The digital signage terminal 100 and the digital signage platform 200 may communicate with each other through the Internet. A web-based digital signage terminal 100 refers to a terminal, which operates in a web browser and is capable of playing contents written in HTML, CSS or Javascript. The digital signage terminal 100 may play an advertising content item that does not interact with a user, and may play a plurality of advertising content items on a single screen according to a predetermined schedule. In addition, the digital signage terminal 100 may play an interactive content item designated by interaction with a user. Accordingly, if a request for an interactive content item is received when an advertising content item is being played, the signage terminal 100 may stop playing the advertising content item, and instead start to play the requested interactive content item.

The digital signage platform 200 is a platform for providing a digital signage service.

In one embodiment, if there is a request for an interactive content when playing an advertising content item, the digital signage terminal 100 starts to play the requested interactive content item. As a result, the advertising content item stops to be played, and thus, a preset exposure time of the advertisement content item is not ensured. In order to solve this drawback, the digital signage platform 200 allows the non-played part of the advertising content item to be played in the digital signage terminal 100 immediately after the interactive content item is completely played. At this point, a layout in which the non-played part of the advertising content item is to be played may be reconfigured dynamically.

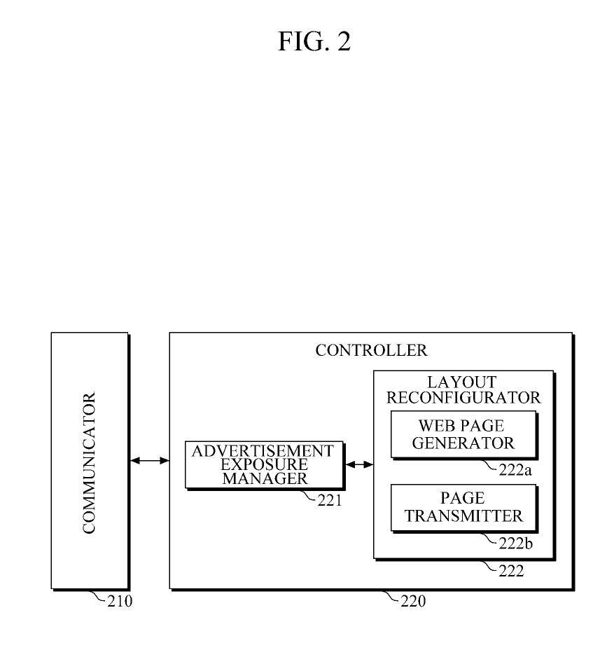

FIG. 2 is a block diagram illustrating a digital signage platform according to an exemplary embodiment. As illustrated in FIG. 2, a digital signage platform 200 includes a communicator 210 and a controller 220. The communicator 210 provides a network interface, as known in the art. The controller 220 may control the overall operations of a platform. When the digital signage terminal 100 stops playing an advertising content item and instead starts to play an interactive content item, the controller 220 processes a non-played part of the advertising content item to be played immediately after the interactive content item is completely played. As such, although an advertising content item stops to be played due to an interactive content item, an exposure time of the advertising content item is ensured.

In one embodiment, the controller 220 may include an advertisement exposure manager 221 and a layout reconfigurator 222. These elements may be software modules that are able to be implemented in a hardware processor. The advertisement exposure manager 221 may in real-time identify and manage an exposure time of each of a plurality of advertising content items that are played according to a schedule. In one embodiment, the digital signage terminal 100 may constantly transmit feedback on an exposure time of each advertising content item to the digital signage platform 200, so that the advertisement exposure manager 221 may identify the exposure time of each advertising content item based on the feedback received from the digital signage terminal 100. In one embodiment, the advertisement exposure manager 221 may calculate a remaining play time of an advertising content item based on a total play time and the exposure time of the advertising content item, and may calculate a weight of the advertising content item based on the calculated remaining play time of the advertising content item. In one embodiment, the advertisement exposure manager 221 may calculate a weight of an advertising content item based on a ratio of a remaining play time to a total play time thereof. The following notations may be used to provide more clear understanding of the explanation.

tᵢ: i^{th} a total play time of the i^{th} advertisement

eᵢ: i^{th} _{an exposure time of the i}^{th} advertisement

rᵢ: i^{th} _{r a remaining play time of the i}^{th} advertisement (rᵢ=tᵢ−eᵢ)

ωᵢ: i^{th} a weight of the i^{th} advertisement (ωᵢ=rᵢ/Σ_{i∈}_{I}rᵢ)

Based on management information of the advertisement exposure manager 221, the layout reconfigurator 222 may dynamically reconfigure a layout in which a non-played part of an advertising content item is to be played. For example, the layout reconfigurator 222 may reconfigure a layout according to a weight of each advertising content item. At this point, an advertising content item with a greater weight is allocated with a relatively larger area, while an advertising content with a lesser weight is allocated with a relatively smaller area. In one embodiment, the layout reconfigurator 222 may include a web page generator 222a and a page transmitter 222b. The web page generator 222a generates a new web page with a layout reconfigured such that advertising content items are allocated with different sized areas according to weights of the advertising content items. When an interactive content item is completely played, the page transmitter 222b transmits to the digital signage terminal 100 information on the new web page generated by the web page generator 222a. Accordingly, the digital signage terminal 100 may play a non-played part of an advertising content item with a layout that is reconfigured based on a weight of the advertising content item.

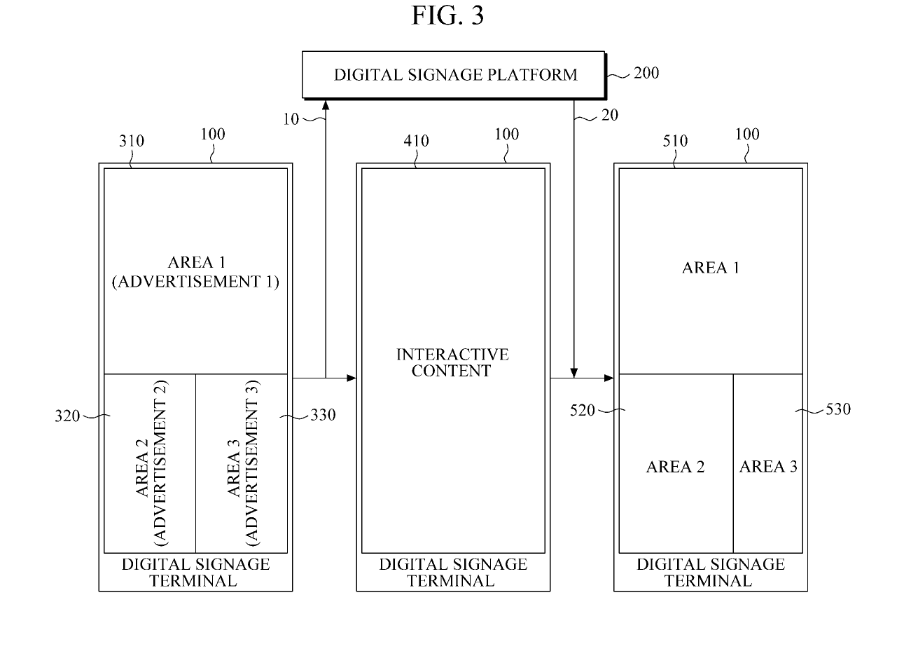

FIG. 3 is a reference diagram for explaining how to change a layout of a screen of a digital signage terminal according to an exemplary embodiment. Referring to FIG. 3, if a command 10 is transmitted to a digital signage platform 200 due to an access or a touch of a user to a digital signage terminal 100 at a time when the digital signage terminal 100 is simultaneously playing general advertising content items 310, 320 and 330 that do not interact with the user, a web page is changed to display a interactive content item 410. As a result, the advertising content items 310, 320 and 330 stops to be played on a screen of the digital signage terminal 100, and the interactive content item 410 starts to be played, so that a preset exposure time of each of the advertising content items 310, 320 and 330 is fully taken. Thus, it needs to compensate the loss of the exposure time of each of the advertising content items 310, 320 and 330. An algorithm for compensating the loss of the exposure time is implemented in the digital signage platform 200. For example, as the digital signage platform 200 transmits a layout change command to the digital signage terminal 100 at a time when the interactive content item 410 is completely played, the digital signage terminal 100 may play the advertising content items 510, 520 and 530 in a changed layout thereof.

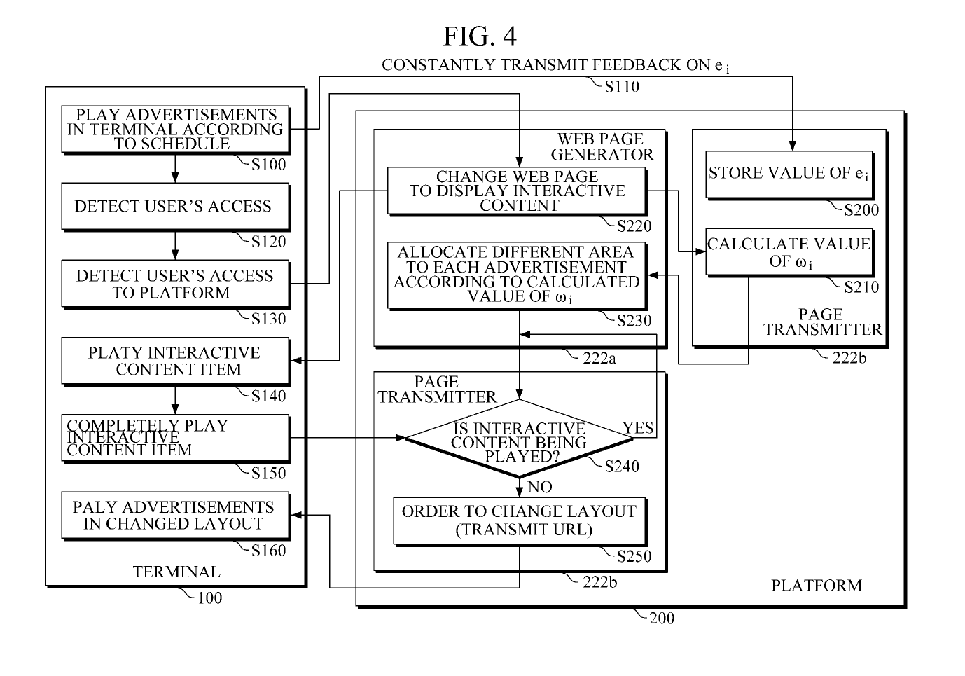

FIG. 4 is a flow chart illustrating operations of a digital signage system according to an exemplary embodiment. A digital signage terminal 100 plays advertisements according to a schedule in operation S100. In addition, while playing the i-th advertisement, the digital signage terminal 100 constantly transmits a feedback on the actual exposure time eᵢ of the i-th advertisement in operation S 110. An advertisement exposure manager 221 of a digital signage platform 200 may constantly store the exposure time eᵢ in operation S200, and may calculate a weight ωᵢ of each advertisement in real-time in operation S210. If a user's access that requests interactive content occurs, the digital signage terminal 100 transmits a feedback on the user's access to the digital signage platform 200 in order to make a shift from the advertisement into the requested interactive content in operations S120 and S130. The web page generator 222a changes a web page to play the interactive content in operation S220, and accordingly, the digital signage terminal 100 starts to play the interactive content in operation S140. At the same time, the advertisement exposure manager 221 calculates a weight of each advertising content item at a time when a screen of the digital signage terminal 100 starts to display the interactive content, and transmits the calculated weight of each advertisement to a web page generator 222a. The web page generator 222a generates a new web page with a layout reconfigured such that advertisements are allocated with different sized areas according to weights of the advertisements in operation S230. Then, after the interactive content is completely played, the digital signage terminal 100 transmits an interactive content end signal to the digital signage platform 200 in operation S150. In response to the interactive content end signal, a page transmitter 222b of the digital signage platform 200 orders to change a layout of the screen, by transmitting URL information of the new web page generated by the web page generator 222a to the digital signage terminal 100 in operation S240 and S250. Accordingly, the digital signage terminal 100 may play general advertisements in a layout that is changed based on weights of the advertisements.

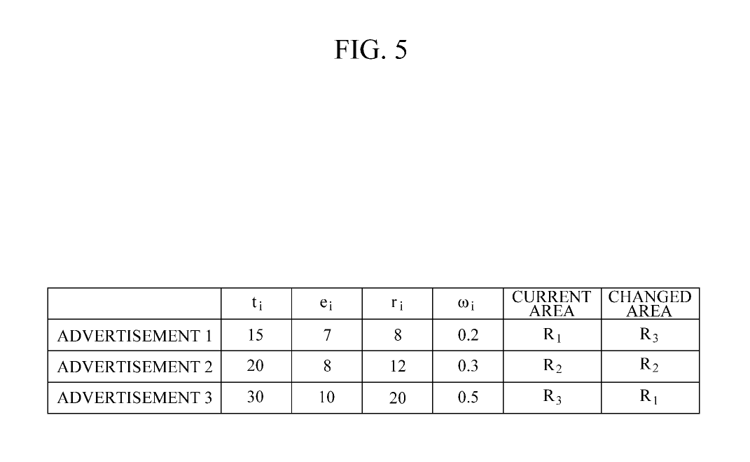

FIG. 5 is a chart illustrating information managed by an advertisement exposure manager according to an exemplary embodiment. The chart in FIG. 5 shows how to calculate a weight of an advertising content item, and it is described with reference to FIG. 3. Suppose that advertisements 1, 2 and 3 have a total play time tᵢ of 15, 20 and 30 seconds, respectively, and that the advertisements 1, 2 and 3 are now being played in different areas R1, R2 and R3 (which are respectively represented as reference numbers 310, 320 and 330 in FIG. 3.). If the advertisements 1, 2 and 3 have been played for 7, 8 and 10 seconds until an interactive content item starts to be played, an advertisement manager 221 may calculate a remaining play time r i of each of the advertisements 1, 2 and 3 based on a value of eᵢ, which is received from the digital signage terminal 100, and then may calculate a weight w, of each of the advertisements 1, 2 and 3. In the example shown in FIG. 5, the advertisements 1, 2 and 3 have a weight of 0.2, 0.3 and 0.5, respectively. It means that the advertisement 1 is played in an area R1 (which is represented by the reference number 530 in FIG. 3) accounting for 20% of the screen; the advertisement 2 is played in an area R2 (which is represented by the reference number 520 in FIG. 3) accounting for 30% of the screen; and the advertisement 3 is played in an area R3 (which is represented by the reference number 510 in FIG. 3) accounting for 50% of the screen.

According to the present disclosure, an exposure time of an advertisement is ensured even in the case where the advertisement stops to be exposed due to an interactive service.

In particular, according to the present disclosure, an actual advertisement exposure time is constantly managed in a platform, and the resultant management information is applied to an algorithm that continuously calculates a weight of each advertisement so that an exposed area and an exposed size of each advertisement is reconfigured when a user ends an interactive service and resumes playing of each advertisement. Bu implementing an algorithm that changes a location and size of an area in which an advertisement is to be played according to an actual exposure time of the advertisement, it is possible to meet an advertiser's demand for ensuring a fair advertisement exposure time. In addition, the present disclosure assumes a web-based digital signage terminal, so that a new screen may be generated more easily when contents are reconfigured.

Those who are skilled in the related art may understand that various and specific modifications may be made without modifying the technical ideas or essential characteristics of the invention. Accordingly, the embodiments disclosed above are exemplary, and should be understandable not to be limited to in all aspects.

What is claimed is:

1. A digital signage system capable of ensuring an advertisement exposure time, the digital signage system comprising a digital signage platform configured to comprise:
a controller configured to, in response to an event that an advertising content stops to be played in a digital signage terminal due to an interactive content item requested to be played, allow a non-played part of the advertising content item to be played at a time when the interactive content item is completely played.

2. The digital signage system of claim 1, wherein the controller is further configured to reconfigure a layout in which the non-played part of the advertising content item is to be played.

3. The digital signage system of claim 2, wherein the controller is further configured to comprise:
an advertisement exposure manager configured to identify an exposure time of each of different advertising content items until the different advertising content items stops to be played, to calculate a remaining play time of each of the different advertising content items based on a total play time and the identified exposure time thereof, and to manage the calculated remaining play time; and
a layout reconfigurator configured to reconfigure a layout based on management information of the advertisement exposure manager, and to provide the reconfigured layout to the digital signage terminal.

4. The digital signage system of claim 3, wherein the advertisement exposure manager is further configured to constantly receive a feedback on an exposure time of each of currently played advertising content item from the digital signage terminal.

5. The digital signage system of claim 3,
wherein the advertisement exposure manager is further configured to calculate a weight of each of the different advertising content items based on the remaining play time thereof, and the layout reconfigurator is further configured to reconfigure a layout for each of the different advertising content items based on the calculated weight thereof.

6. The digital signage system of claim 5, wherein the layout reconfigurator is further configured to comprise
a web page generator configured to generate a new web page with a layout reconfigured such that each of the different advertising content items are allocated with a different sized area according to a weight of each of the advertising content items; and
a page transmitter configured to transmit information on the new web page when the interactive content is completely played.

7. An advertisement exposure time ensuring method of a digital signage, the method comprising:
in response to a request received from a digital signage terminal for an interactive content item when the digital signage terminal is playing advertising content items, providing a web page to play the interactive content items to the digital signage terminal; and
in response to an event that the interactive content item is completely played, providing a web page to play a non-played part of each of the advertising content items.

8. The advertisement exposure time ensuring method of claim 7, wherein the providing of a web page to play a non-played part of each of the advertising content items comprises reconfiguring a layout in which the non-played part of each of the advertising content items is to be played.

9. The advertisement exposure time ensuring method of claim 8, wherein the providing of a web page to play a non-played part of each of the advertising content items further comprises:
identifying an exposure time of each of the advertising content items;
calculating a remaining play time of each of the advertising content items based on a total play time and the identified exposure time thereof;
calculating a weight of each of the advertising content items based on the calculated remaining play time; and
reconfiguring a layout by allocating each of the advertising content items are allocated with a different sized area according to the calculated weight.
